(19) United States
(12) Patent Application Publication
(10) Pub. No.: US 2007/0108717 A1
(43) Pub. Date: May 17, 2007

(54) ELONGATE SPRING MEMBER HAVING BUSHING MOUNTS WITH IMPROVED BUSHING RETENTION CHARACTERISTICS

(76) Inventors: Donald Stoesz, Landgon, MB (CA); Melvin Svendsen, Calgary, MB (CA)

Correspondence Address: ADE & COMPANY INC., 2157 Henderson Highway, WINNIPEG, MB, R2G1P9, CA

(21) Appl. No.: 11/552,012

(22) Filed: Oct. 23, 2006

Related U.S. Application Data
(60) Provisional application No. 60/728,802, filed on Oct. 21, 2005.

(51) Int. Cl. B60G 11/00; F16F 1/26

(52) U.S. Cl. 280/124.175; 267/260

(57) ABSTRACT

Cylindrical bushing mounts, or eyes, for spring members have improved bushing retention characteristics over conventional mounts. In a first embodiment, a spring member has a bushing mount formed by forging to be integral with the spring beam and define an endless loop that fully encloses a cylindrical opening for receiving a bushing. The integral mount better resists deformation under loading than typical rolled mounts having an open end, and therefore can be made having a thinner cross section to reduce the weight of the beam. In a second embodiment, a spring member features a rolled mount having a profiled inner surface defining ridges protruding inward at each end of the mount's cylindrical opening. A bushing received in the mount is housed between the ridges, eliminating the need for an interference fit or bonding compound to retain the bushing.

This application claims the benefit under 35 U.S.C.119(e) of U.S. provisional application Ser. No. 60/728,802, filed Oct. 21, 2005.

### FIELD OF THE INVENTION

This invention relates to spring members having bushing mounts, and more particularly to a spring members having bushing mounts with improved bushing retention characteristics.

### BACKGROUND OF THE INVENTION

Elongate spring members, such as leaf springs and spring beams, are often used in vehicle suspension systems designed to resiliently connect a vehicle's axle(s) to its frame. However such spring members can be used in many different situations and the present invention is applicable to any of these and is not intended to be limited to vehicle suspensions.

An example of an application for elongate spring members relates to air bag suspension systems, which are applied in great number to heavy truck fleets utilized in the transport industry. Air suspensions for large commercial trucks are used for on and off highway use, such as highway tractor and off road construction vehicles. In such systems, one end of a spring beam features a bushing mount, or eye, for pivotally attaching the spring beam to the frame. An air bag at the other end is supported between the spring beam and a frame element, while the axle is coupled to the spring beam between the two ends. The air bag's resiliency to compression serves to limit pivotal motion of the spring beam and attached axle towards the frame. Bushing mounts are commonly used in applications where it is desirable to pivotally mount a spring member at its end(s).

Typically, a bushing mount is of a rolled form with an open end and straight internal profile, thereby defining a cylindrical opening, or eye, for housing a bushing therein. Again using vehicle suspension as an example, a pivot pin passed through the bushing supports the spring beam for pivotal motion on the vehicle frame while the bushing prevents direct contact of the pin and spring beam to reduce wear caused by relative motion therebetween. The open ends of these standard rolled mounts tend to open further during deformation caused by excessive loading. This deformation changes the size and shape of the eye so that the bushing is no longer properly seated and firmly secured therein.

FIG. 1 illustrates two spring beams 10 having typical prior art bushing mounts 12 formed by rolling an end 14 of the elongate spring beam 10 back over itself, leaving a gap 16 between the end 14 and the upper surface 17 of the beam 10. The beam at the top of the figure is shown undergoing linear loading as indicated by the arrows extending in the same direction from the rolled end of the beam 10. It should be appreciated that these generally longitudinal forces exerted on the bushing mount 12 along the beam 10 tend to cause the mount 12 to unroll, pulling the end 14 of the beam away from the upper surface 17 and increasing the size of the opening 16. The beam at the bottom of the figure is shown undergoing torsional loading as indicated by the arrows representing opposing forces on opposite sides 18 and 20 of the bushing mount 12. It should be appreciated that the twisting caused by the opposing forces will tend to push the end 14 of the beam away from the upper surface 17 on the side 18 with the upward force. This side loading induces a shearing action against the bushing.

Regardless of the type of loading, deformation of the bushing mount 12 will cause the size and shape of a cylindrical opening 22 formed by the rolled end 14 to change. It is important to maintain consistency in this opening 22, as it houses a bushing 24 and a pin 26 by which the beam 10 is pivotally supported. Maintaining the size of the opening 22 is thus very important as retention of the bushing 24 therein is necessary to support the spring beam 10 and prevent failure of the suspension system.

As shown in FIG. 4, the cross section of a typical bushing mount is rectangular defining such that an inner surface 28 defining the cylindrical opening 22 is of a constant diameter. An externally sleeved bushing having an outer metal shell is often used with these standard mounts so that an interference fit between the shell and the mount of the spring beam can be used to secure the bushing in place. As a result of the interference fit, the bushing is under stress immediately upon installation, which increases the rate of wear. As an alternative to externally sleeved bushings, an externally unsleeved bushing can be bonded to the inner surface of the mount to secure it within the eye of the spring beam. Bonding compounds are expensive and susceptible to damage due to environmental conditions such as temperature extremes and chemical reactions. Bonding compounds also require tightly controlled surface contact, which as mentioned above, may be lost due to opening of rolled bushing mounts under excessive loading.

U.S. Pat. No. 5,366,238 of Stephens teaches a spring member produced from a one inch thick blank of spring steel and having an integral eye. The material is cut using plasma arc cutting techniques to produce an elongate spring member having a vertical depth greater than its horizontal width. The production of a spring member from such a relatively thin blank may place undesirable limits on the shape and dimensions of an achievable end product.

U.S. Pat. No. 3,671,030 of Marion teaches a leaf spring having an integral eye formed by creating two slits proximate one of its ends parallel to its length, then displacing an intermediate portion of the leaf between the slits and adjacent edge portions outside the slits in opposite directions to create opposed semi-cylindrical loops. In this arrangement, the spring material does not extend the full length of the eye thereabove and therebelow, which may limit the strength of the bushing mount.

As a result, there is a desire for spring members producible in various sizes and shapes having bushing mounts that offer improved bushing retention characteristics, thereby improving the safety and reliability levels of the suspension systems in which they are used.

### SUMMARY OF THE INVENTION

According to a first aspect of the invention there is provided a combination of a suspension assembly and a frame, said combination comprising;

an elongate spring member having opposite first and second ends, said spring member being pivotally supported on the frame at said first end; and

a coupling supported on the elongate spring member and spaced from the first end thereof, said coupling thereby being supported on the frame by said spring member;

the elongate spring member comprising a forged mounting element at the first end thereof, said forged mounting element having a cylindrical inner surface defining a cylindrical opening extending transverse to said spring member, said spring member being pivotal about said opening;

the forged mounting element being integral with the elongate spring member and the inner surface of said forged mounting element being endless about the cylindrical opening.

The forged integral bushing mount forms an endless loop around the cylindrical opening extending the full width of the sprin. By eliminating the open end found in typical rolled bushing mounts, the integral mount better resists deformation under loading conditions. As a result, the forged mount can be made to have a thinner cross section than the typical rolled form, thereby decreasing the overall weight of the spring member.

A width of the elongate spring member may exceed a thickness thereof.

Side edges of the elongate spring member may each deviate from a planar path along a length thereof.

Preferably there is provided a bushing disposed in and extending along the cylindrical opening of the forged mounting element. In this case, there may be provided a pin supported on the frame and extending through the bushing in the cylindrical opening, the spring member being pivotal about said pin.

Preferably the coupling comprises an axle seat.

The spring member may comprise a spring beam.

There may be provided an air spring bag supported on the spring member and spaced from the first end thereof, said air spring bag being disposed between said spring member and the frame so as to resist pivotal motion of said spring member about the first end thereof toward said frame. In this case, preferably the coupling is disposed between the first end of the spring member and the air spring bag and the air spring bag is disposed at the second end of the spring member.

According to a second aspect of the invention, there is provided a combination of a suspension assembly and a frame, said combination comprising:

an elongate spring member having opposite first and second ends, said spring member being pivotally supported on the frame at said first end; and

a coupling supported on the elongate spring member and spaced from the first end thereof, said coupling thereby being supported on the frame by said spring member;

the elongate spring member comprising a mounting element at the first end thereof, said mounting element having an inner surface defining an opening extending transverse to said spring member, said spring member being pivotal about said opening; and

the inner surface of the mounting element comprising:
a substantially cylindrical portion having opposite ends defining a length of the opening; and
substantially annular ridge portions at the opposite ends of the cylindrical portion, said ridge portions extending inward from said cylindrical portion such that the opening is smaller at said ridge portions than at said cylindrical portion.

The ridges at the opposite ends of the cylindrical opening reduce the inner diameter of the mount on each side of the spring member. These ridges are thereby arranged to house a component having an outer diameter greater than the inner diameter of the ridges between them.

Preferably there is provided a bushing disposed in the opening of the mounting element and extending along the substantially cylindrical portion of the inner surface of said mounting element, said bushing being larger between the ridge portions of said inner surface than said opening at said ridge portions of said mounting element such that said ridges prevent said bushing from sliding out of said opening. In other words, there may be provided a bushing disposed in the opening of the mounting element, the bushing comprising a substantially cylindrical main portion disposed between the ridge portions of the inner surface of the mounting element, the main portion having an outer diameter larger than the opening of the mounting body at the ridge portions.

Securely housed between the ridges, a bushing without an external metal sleeve or bonding compound can be retained in the bushing mount. Without the stress exerted on the bushings by an interference fit between the outer sleeve and the inner surface of the mount, the bushing life is extended. Also, the high cost and environmental susceptibility associated with bonding compounds are avoided.

Preferably the bushing comprises tapered portions narrowing toward opposite ends thereof from an outer diameter larger than the opening of the mounting element at the ridge portions. Preferably the outer diameter narrows to a size smaller than the opening of the mounting element at the ridge portions.

Preferably the inner surface of the mounting element further comprises two transitional portions each extending, and gradually decreasing in diameter, from the cylindrical portion to a respective one of the ridge portions.

Preferably the ridge portions, extending away from the central portion and the transitional portions, are of constant diameter.

Preferably the tapered portions of the bushing and the transitional portions of the inner surface of the mounting element having generally equal slopes.

Preferably the main portion of the bushing is generally equal in length to the cylindrical portion of the inner surface of the mounting element.

Preferably the outer diameter of the main portion of the bushing does not exceed a diameter of the cylindrical portion of the inner surface of the mounting element,

Preferably the mounting element is integral with the elongate spring member and the inner surface of said mounting element being endless about the cylindrical opening.

Preferably each ridge portion extends fully about the opening.

According to a third aspect of the invention, there is provided a combination of a suspension assembly and a frame, said combination comprising:

an elongate spring member having opposite first and second ends, said spring member being pivotally supported on the frame at said first end; and

a coupling supported on the elongate spring member and spaced from the first end thereof, said coupling thereby being supported on the frame by said spring member;

the elongate spring member comprising a mounting element at the first end thereof, said mounting element having an inner surface defining an opening extending transverse to said spring member, said spring member being pivotal about said opening; and

the inner surface of the mounting element comprising:
a cylindrical portion having opposite ends defining a length of the opening; and
annular ridge portions at the opposite ends of the cylindrical portion, said ridge portions extending inward from said cylindrical portion such that the opening is smaller in diameter at said ridge portions that at said cylindrical portion;

the mounting element being integral with the elongate spring member and the inner surface of said mounting element being endless about the cylindrical opening.

According to a fourth aspect of the invention there is provided a spring element comprising:

an elongate member having opposite ends, at least one of said ends comprising a forged mounting element having a cylindrical inner surface defining a cylindrical opening extending transverse to said elongate member,

the forged mounting element being integral with the elongate spring beam and the inner surface of said forged mounting element being endless about the cylindrical opening.

According to a fifth aspect of the invention there is provided a spring element comprising:

an elongate member having opposite ends, at least one of said ends comprising a mounting element having an inner surface defining an opening extending transverse to said elongate member;

the inner surface of the mounting element comprising:
a substantially cylindrical portion having opposite ends defining a length of the opening; and
substantially annular ridge portions at the opposite ends of the cylindrical portion, said ridge portions extending inward from said cylindrical portion such that the opening is smaller at said ridge portions than at said cylindrical portion.

According to a sixth aspect of the invention there is provided a spring element comprising:

an elongate member having opposite ends, at least one of said ends comprising a mounting element having an inner surface defining an opening extending transverse to said elongate member;

the inner surface of the mounting element comprising:
a cylindrical portion having opposite ends defining a length of the opening; and
annular ridge portions at the opposite ends of the cylindrical portion, said ridge portions extending inward from said cylindrical portion such that the opening is smaller in diameter at said ridge portions than at said cylindrical portion;

the mounting element being integral with the elongate spring beam and the inner surface of said mounting element being endless about the cylindrical opening.

### BRIEF DESCRIPTION OF THE DRAWINGS

In the accompanying drawings, which illustrate exemplary embodiments of the present invention:

FIG. 1 is a partial isometric view of spring beams having prior art bushing mounts shown under linear and torsional loading.

FIG. 2 is an isometric view of three types of spring beams having bushing mounts according to a first embodiment of the present invention.

FIG. 3 is a partial isometric view of a spring beam having a bushing mount according to the first embodiment of the present invention partly cut away to illustrate the mounting of an externally sleeved bushing within.

FIG. 4 is a cross sectional view of one of the prior art bushing mounts of FIG. 1.

FIG. 5 is a cross sectional view of a bushing mount according to a second embodiment of the present invention.

FIG. 6 is a partial isometric view of a spring beam having a bushing mount according to the second embodiment of the present invention partly cut away to show an unsleeved bushing housed therein.

FIG. 7 is a partial isometric view of spring beams having bushing mounts according to a third embodiment of the present invention partly cut away to illustrate the retention of an externally unsleeved bushing therein.

FIG. 8 is a side elevation view of an air suspension system using a spring member in accordance with the present invention.

### DETAILED DESCRIPTION

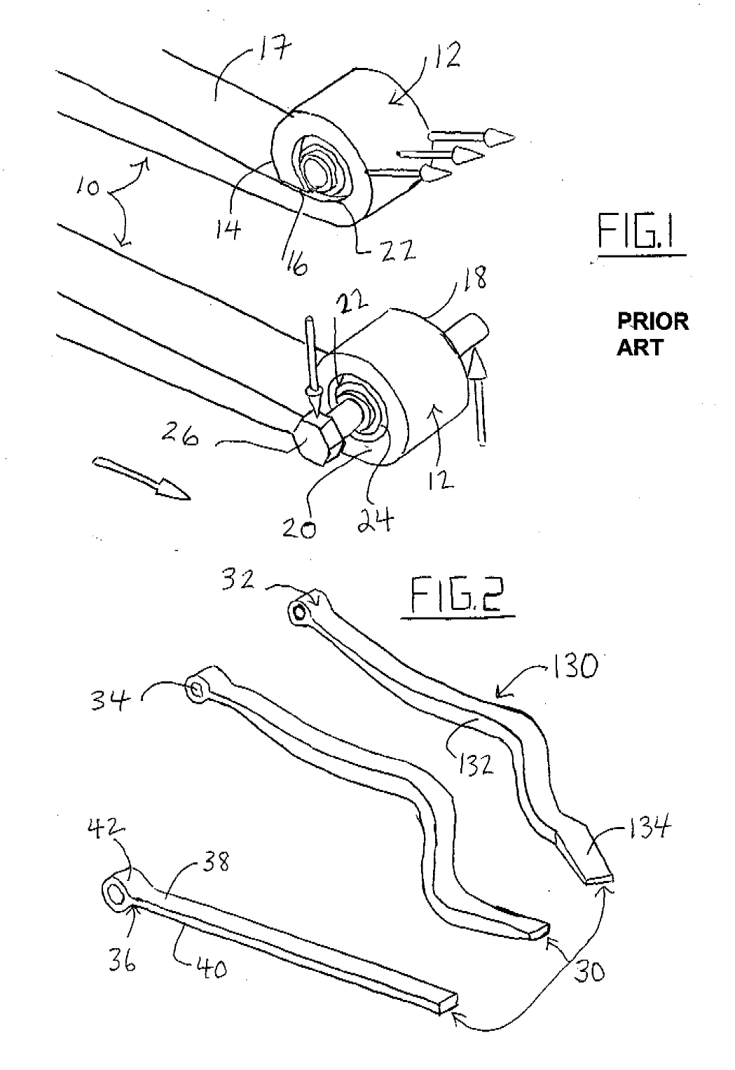

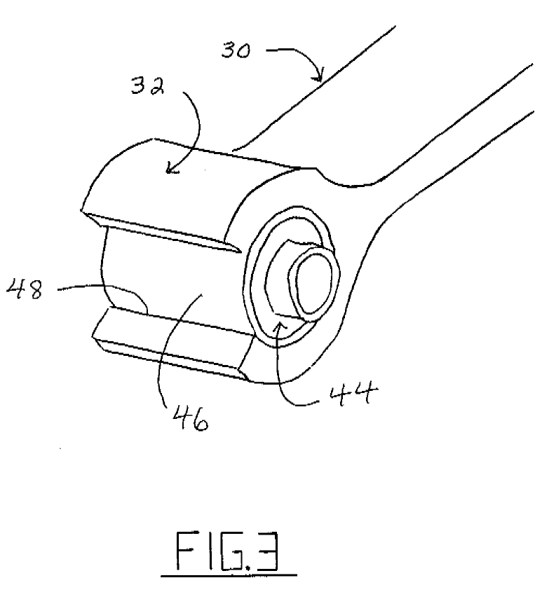

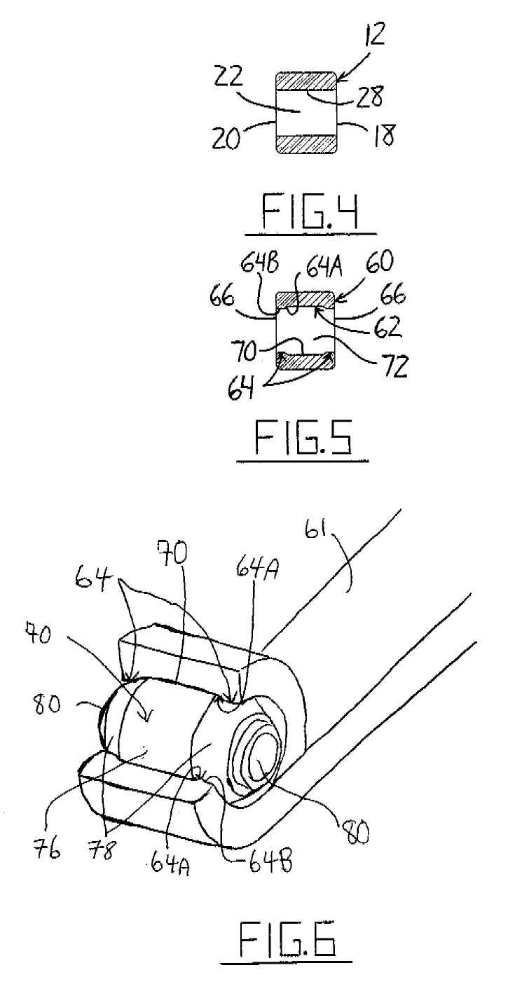

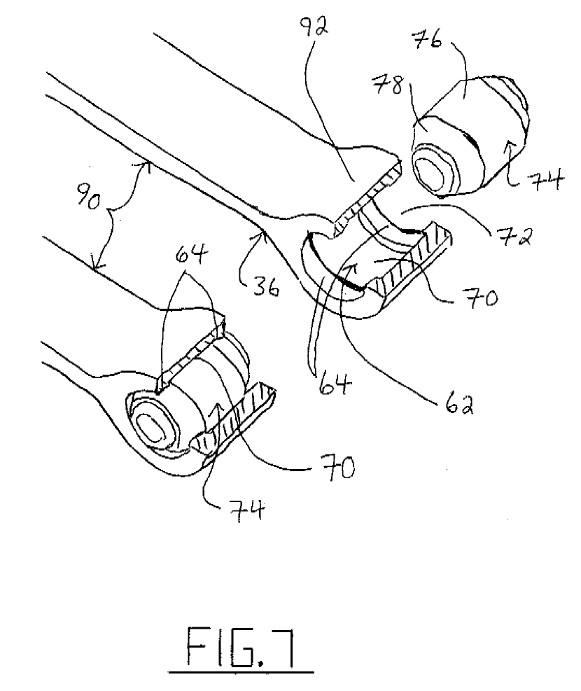

FIG. 2 shows three spring beams 30 commonly used in suspension systems: a straight beam, a Z-beam and a twisted Z-beam. Each beam 30 features a bushing mount 32 according to a first embodiment of the present invention. These beams do not feature the open rolled ends 14 of the prior art beams 10 of FIG. 1 and therefore do not have the gaps 16 between the end and the upper surface 17 of the beam. Instead, the bushing mounts 32 are formed integrally with the beams 30 by a forging process to define and endless loop extending the full width of each spring member at its mounting end. Forming such a beam involves forging an end of an elongate spring member to form a mounting element integral with the spring member and having a cylindrical inner surface defining a cylindrical opening extending transverse to the elongate member, the inner surface being endless about the cylindrical opening and continuous from one end of the opening to the other. As a result, the cylindrical opening 34 is completely enclosed by the continuous, hollow bushing mount 32 at the mounting end of the beam 30. These bushing mounts 32 are stronger than conventional rolled ends due to their closed structure and therefore can better resist deformation and properly secure bushings therein. This continuous design thereby allows beams 30 to be constructed from less material to have similar strength to beams 10 of the prior art, or can be constructed to have greater strength than the prior art without increasing the material requirements. Reducing the amount of material by reducing the cross sectional thickness of the bushing mounts 32 reduces the overall weight of the beam 30. A lighter suspension system improves vehicle fuel economy and reduces material costs during production.

A transitional area 36 between the bushing mount 32 and the upper and lower surfaces 38 and 40 of the spring beam 30 features smooth curves between the generally flat surfaces of the beam and the round outer surface 42 of the mount. These curves, or lead in radii avoid the presence of sharp corners which can lead to premature failure of the beam 30, as sharp corners experience higher stress concentrations than rounded corners during loading.

Like those of typical spring beams, the bushing mounts 32 of the first embodiment can house externally sleeved or unsleeved bushings. As shown in FIG. 3, externally sleeved bushings 44 feature a metal outer sleeve 46 that is disposed between the bushing and the inner surface 48 of the mount. The diameters of the sleeve 46 and the inner surface 48 are carefully selected and controlled to provide an interference, or press, fit known to those of skill in the art. In such an arrangement, the outer diameter of the sleeve 46 is slightly larger than the diameter of the mount's inner surface 48, such that the bushing must be forced into the mount under stress. This tight fit serves to retain the externally sleeved bushing 44 within the mount 32 and prevent separation of the two components. FIG. 3 also shows a bushing 50 having no external sleeve housed within the rolled bushing mount 12 of a typical spring beam 10. Such bushings 50 are held in place by bonding compounds known to those of skill in the art. These compounds can also be used to bond the outer surface 52 of an externally unsleeved bushing 50 to the inner surface 48 of the mount 32 of the first embodiment of the present invention to prevent separation.

The first embodiment of the present invention improves the bushing retention characteristics of the bushing mount of a spring beam without modifying the type of bushing used or the way the bushing is secured in the cylindrical opening. By forging the end of the beam 30 to form the integral mount 32, the opening 34 is completely enclosed and therefore less prone to deformation. The continual loop structure of the mount 32 can be made to have a thinner cross section of material than the open loop of the prior art due to this improved resistance to deformation, thereby reducing the overall weight of the beam 30. The forged mount 32 deflects in a consistent manner regardless of the direction of loading. This equalized loading situation will extend the life of the bushing so that less frequent replacement is required.

FIGS. 4 and 5 show cross sectional views of a typical bushing mount 12 and a bushing mount 60 according to a second embodiment of the invention, respectively. Each of these mounts is formed by rolling and therefore forms an unclosed loop like those shown in FIG. 1. The mounts 12 and 60 differ in the shape of their inner surfaces 28 and 62 respectively. The typical bushing mount 12 features an inner surface 28 of constant diameter from one side 18 of the mount 12 to the other side 20, thereby defining the cylindrical opening 22 of uniform diameter extending fully across the mount 12. The bushing mount 60 of the second embodiment however, features a profiled inner surface 62 having ridges 64 extending inward at the opposite ends 66 of an opening 72 through the mount 60. Between the ridges 64, a central portion 70 of the inner surface 62 is of constant diameter. This profile of the inner surface 62 results in the opening 72 being smaller at the ends 66 than in the center of the mount 60. Each ridge 64 features a transitional portion 64A extending from the central portion 70 of the bushing mount's inner surface 62 to a constant diameter portion 64B of the ridge 64. The transitional portion 64A is sloped to create a gradual decrease in diameter from the central portion 70 of the inner surface to the constant diameter portion 648 of the ridge extending radially inward. In other words, the transition portion not only extends inward from the central portion toward the longitudinal axis of the opening 72, but also outward from the central portion along a longitudinal axis of the opening 72.

FIG. 6 shows a spring beam 61 featuring the ridged mount 60. The ridges 64 of the mount 60 are used to retain a bushing 74 within the opening 72 of the mount without the need for an external sleeve or bonding compound. This type of bushing 74 features a cylindrical main portion 76 of constant diameter having frusto-conical portions 78 at its ends that decrease in diameter as they extend longitudinally away from the main portion 76 toward opposite ends 80. It should be appreciated that the shape of the profiled inner surface 62 of the mount 60 and thus the shape of the opening 72 therethrough correspond to the shape of this type of bushing 74. The diameter of the central portion 70 of the mount's inner surface 62 is made generally equal to that of the bushing's main portion 76 so that the diameter of the main portion 76 is larger than the opening 72 of the mount 60 at the end ridges 64. As such, once installed in the mount 60, the bushing 74 is prevented from sliding out of the opening 72 by engagement of the main portion 76 of the bushing with either of the ridges 64 of the mount's inner surface 62. More specifically, the transition portion 64A of each ridge 64 blocks movement of the bushing 74 out of the opening 72 through its respective end of the bushing mount 60 through contact with the respective frusto-conical portion 78A of the bushing. The main portion 76 of the bushing is of the same length of the central portion 70 of the mounting element and the frusto-conical portions of the bushing taper with the same slope as the transition portions 64A of the mounting element to provide a flush fit between the surfaces of the bushing and the mount. The diameter of the main portion 76 of the bushing does not exceed that of the central portion 70 of the element, as the ridges eliminate the need for an interference fit.

The ridges, or lips, at the ends of the bushing mount of the second embodiment encapsulate the bushing to withstand lateral loads transmitted by a suspension system. Without the stress induced by an interference fit between the mount and an externally sleeved bushing, the life of the bushing is improved. Also, the use of costly, condition sensitive bonding compounds is avoided. It should be appreciated that reducing the number of components required in the suspension assembly also reduces the number of variables involved in its function and/or failure. In this case, a three part combination of a bushing, a spring beam and a retaining component therebetween (for example, a sleeve or bonding compound) has been reduced to a two part combination of a bushing and a spring beam. Bushings are installed into the ridged bushing mount 60 with the aid of a tapered installation sleeve or shallow funnel. Bushings are generally only removed after failure, in which case the bushings would be loose in the mount 60 and therefore easy to remove.

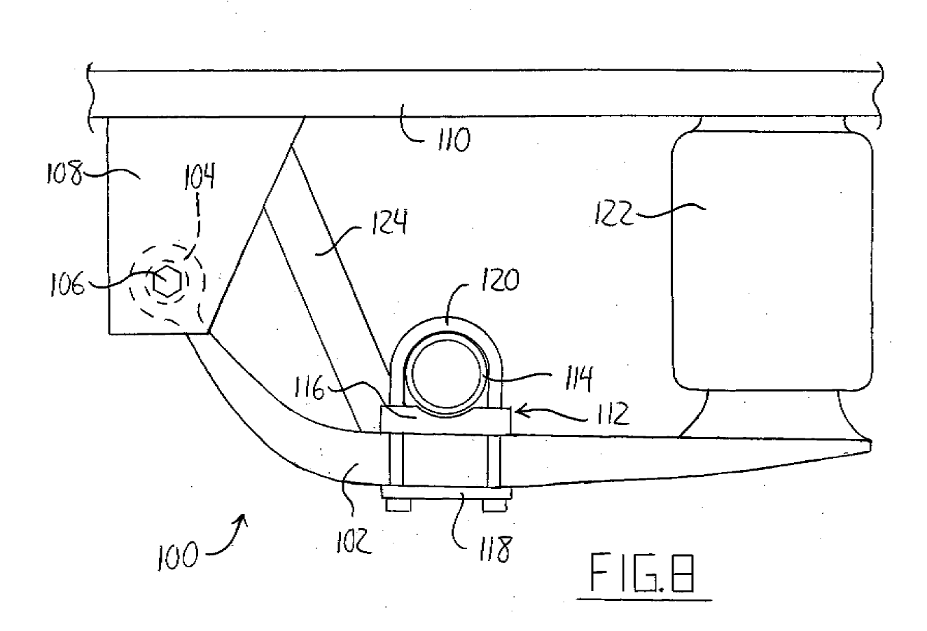

FIG. 7 shows spring members 90 having bushing mounts 92 according to a third embodiment of the present invention that combines the features of the first two. As can be seen in the transition area 36 at the end of the spring beam 90 just before the mount 92, the mount is integral with the spring beam and thus forms an endless loop defining an opening 72 therethrough. In the Figure, a portion of the cylindrical mount 92 has been removed in order to better show its inner surface 62. Just as in the second embodiment, the inner surface 62 is profiled to create raised lips or ridges 64 at the ends of the opening 72. Again, the diameters of the cylindrical main portion 76 of the bushing 74 and the central portion 70 of the inner surface 62 of the mount 92 are equal to each other and larger than the diameters of the frustoconical end portions 78 and ridges 64 of the bushing 74 and mount 92 respectively. These ridges 64 or stepped edges trap the bushing 74 within the mount 92 through engagement with the bushing where the main and end portions 76 and 78 meet. This internal profiled form ensures bushing retention while the continuous piece construction deforms in unity and transmits equal deflections into the bushing mount. The retention of the suspension bushing is more assured as the overall deformation of the mount is minimized. The forged bushing mount, or eye, can be smaller in cross section than a rolled mount without a loss in durability. The ridges eliminate the need for externally sleeved or bonded bushings and the closed loop construction eliminates shear planes caused by deflection of a rolled eye against the bushing.

It should be appreciated that the ridges of the mounting element's inner surface need not extend fully about the opening to block withdrawal of the bushing, but that extending the ridges fully along the mounting element improves the strength with which the bushing is secured in place.

FIG. 8 shows an air suspension system 100 using a spring member 102, having a mounting element 104 configured in accordance with the mounting elements of the first or third embodiment, cooperating with conventional air suspension components. A bushing is fitted within the mounting element 104 as described and has a pin 106 extending through it to pivotally support the spring member 102 on a hanger 108 depending downward from a frame 110 of a vehicle. Between the ends of the spring member 102 is a coupling 112 securing an axle 114 of the vehicle to the spring member thereabove. The coupling 112 features an axle seat 116 contoured to receive the axle 114 and disposed atop the spring member and a respective mounting plate 118 disposed immediately beneath the spring member. U-bolts 120 extend about the top of the axle 114 and extend downward through the axle seat 116 on opposite sides of the spring member 102 to engage the mounting plate 118 disposed therebeneath. The coupling thus clamps the axle to the spring member. At an end of the spring member opposite the bushing mount 104, an air spring 122 is connected between the spring member 102 and the frame 110. A shock absorber 124 may also be connected between the axle 114 and the frame to improve the ride quality of the vehicle.

In each of the embodiments described above, the mounts provide improved bushing retention over typical spring beam bushing mounts. In each of the three detailed embodiments, the width of the eye is precisely maintained and is finished to achieve a full diameter land on the side where it interfaces with the attaching component. The opening, or bore, through the mount is precision sized to provide a smooth surface for flush engagement with the appropriate type of bushing. It should be appreciated that while described in the context of spring beams used in air suspension systems, the present invention can be applied to bushing mounts for various other applications. For example, leaf springs are commonly mounted with bushings inserted into eyes at their ends for use in suspension applications.

As illustrated by FIG. 2, the bushing mounting elements of the present invention may be forged on various elongate members to form spring members having different final types, shapes and sizes. For example, twisted Z-beam 130 features side edges 132 which deviate from planar paths at the end portion 134 twisted out of alignment with a midplane extending through the remainder of the spring member. Each of the illustrated spring members is greater in width than in thickness, or depth, although the mounting elements may be forged on spring members not having a width to thickness ration greater than one.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A spring element comprising:
an elongate member having opposite ends, at least one of said ends comprising a mounting element having a cylindrical inner surface defining a cylindrical opening extending transverse to said elongate member;
the mounting element being integral with the elongate spring beam and the inner surface of said forged mounting element being endless about the cylindrical opening; and
the mounting element having been formed by forging.

2. The spring element according to claim 1 wherein a width of the elongate spring member exceeds a thickness thereof.

3. The spring element according to claim 1 wherein side edges of the elongate spring member each deviate from a planar path along a length thereof.

4. A combination of a suspension assembly and a frame, said combination comprising:
an elongate spring member having opposite first and second ends, said spring member being pivotally supported on the frame at said first end; and
a coupling supported on the elongate spring member and spaced from the first end thereof, said coupling thereby being supported on the fame by said spring member;
the elongate spring member comprising a mounting element at the first end thereof, said mounting element having an inner surface defining an opening extending transverse to said spring member, said spring member being pivotal about said opening; and
the inner surface of the mounting element comprising:
a substantially cylindrical portion having opposite ends; and
substantially annular ridge portions at the opposite ends of the cylindrical portion, said ridge portions extending inward from said cylindrical portion such that the opening is smaller at said ridge portions than at said cylindrical portion.

5. The combination according to claim 4 further comprising a bushing disposed in the opening of the mounting element and extending along the substantially cylindrical portion of the inner surface of said mounting element, said bushing being larger between the ridge portions of said inner surface than said opening at said ridge portions.

6. The combination according to claim 4 further comprising a bushing disposed in the opening of the mounting element, the bushing comprising a substantially cylindrical main portion disposed between the ridge portions of the inner surface of the mounting element, the main portion having an outer diameter larger than the opening of the mounting body at the ridge portions.

7. The combination according to claim 4 further comprising a bushing disposed in the opening of the mounting element, the bushing comprising tapered portions narrowing toward opposite ends thereof from an outer diameter larger than the opening of the mounting element at the ridge portions.

8. The combination according to claim 7 wherein the outer diameter narrows to a size smaller than the opening of the mounting element at the ridge portions.

9. The combination according to claim 4 wherein the inner surface of the mounting element further comprises transitional portions each extending, and gradually decreasing in diameter, from the cylindrical portion to a respective one of the ridge portions.

10. The combination according to claim 9 wherein the ridge portions, extending away from the central portion and the transitional portions, are of constant diameter.

11. The combination according to claim 9 further comprising a bushing comprising tapered portions narrowing toward opposite ends thereof from an outer diameter lager than the opening of the mounting element at the ridge portions, the tapered portions of the bushing and the transitional portions of the inner surface of the mounting element having generally equal slopes.

12. The combination according to claim 11 wherein the bushing comprises a main portion between the tapered portions, the main portion of the bushing being generally equal in length to the cylindrical portion of the inner surface of the mounting element.

13. The combination according to claim 6 wherein the outer diameter of the main portion of the bushing does not exceed a diameter of the cylindrical portion of the inner surface of the mounting element.

14. The combination according to claim 4 wherein the mounting element is integral with the elongate spring member and the inner surface of said mounting element being endless about the cylindrical opening.

15. The spring element according to claim 14 wherein each ridge portion extends fully about the opening.

16. A spring element comprising:
an elongate member having opposite ends, at least one of said ends comprising a mounting element having an inner surface defining an opening extending transverse to said elongate member;
the inner surface of the mounting element comprising:
a substantially cylindrical portion having opposite ends defining a length of the opening; and
ridge portions at the opposite ends of the cylindrical portion, said ridge portions extending inward from said cylindrical portion such that the opening is smaller at said ridge portions than at said cylindrical portion.

17. The spring element according to claim 16 wherein the mounting element is integral with the elongate member and the inner surface of said mounting element being endless about the cylindrical opening.

18. The spring element according to claim 17 wherein each ridge portion extends fully about the opening.

19. The spring element according to claim 16 wherein the inner surface of the mounting element further comprises transitional portions each extending, and gradually decreasing in diameter, from the cylindrical portion to a respective one of the ridge portions.

20. The combination according to claim 19 wherein the ridge portions, extending away from the central portion and the transitional portions, are of constant diameter.
